(19) United States
(12) Patent Application Publication
(10) Pub. No.: US 2025/0233305 A1
(43) Pub. Date: Jul. 17, 2025

(54) PRINTED CIRCUIT BOARD IMPLEMENTED MULTIBAND ANTENNA

(71) Applicant: Honeywell International Inc., Charlotte, NC (US)

(72) Inventors: AMIT B. KULKARNI, Duluth, GA (US); JUSTIN JOSE, Kerala (IN); PRASAD SAMUDRALA, Suwanee, GA (US)

(21) Appl. No.: 18/410,602

(22) Filed: Jan. 11, 2024

(51) Int. Cl. H01Q 5/30; H01Q 5/28

(52) U.S. Cl. CPC H01Q 5/30; H01Q 5/28

(57) ABSTRACT

A printed circuit board implemented antenna includes an antenna leg supported by a printed circuit board having a plurality of different metal layers. The antenna leg has a length extending between a first end and a second end of the antenna leg. The antenna leg includes a plurality of series connected metal segments. Each of at least two of the plurality of series connected metal segments is electrically connected to at least two neighboring metal segment of the plurality of series connected metal segments, and wherein each of the at least two of the plurality of series connected metal segments is formed on a different metal layer of the printed circuit board than each of the at least two neighboring metal segment and is connected to each of the at least two neighboring metal segment through one or more Vias of the printed circuit board.

### TECHNICAL FIELD

The present disclosure pertains to antennas that may be used in a variety of wireless applications and more particularly pertains to dual band antennas.

### BACKGROUND

A variety of electronic devices utilize antennas for wirelessly transmitting and/or receiving information. In some cases, it may be desirable for an electronic device to have the capability of communicating over two or more different frequency bands. What would be desirable is a dual band antenna that can be easily and inexpensively incorporated into a variety of different electronic devices to support communication over each of two different frequency bands.

### SUMMARY

This disclosure pertains to generally antennas that may be used in a variety of wireless applications and more particularly pertains to dual band antennas having a small frequency band separation. An example may be found in a printed circuit board implemented multiband antenna. The illustrative printed circuit board implemented multiband antenna includes a first antenna leg supported by a printed circuit board, the first antenna leg having a length, with a first end region of the first antenna leg operatively connected to a ground plane of the printed circuit board and a second end region of the first antenna leg extending away from the first end region of the first antenna leg in a first direction. A second antenna leg is supported by the printed circuit board, the second antenna leg having a length, with a first end region of the second antenna leg connected to the second end region of the first antenna leg, and with a second end region of the second antenna leg extending away from the first end region of the second antenna leg in a second direction that is orthogonal to the first direction. A third antenna leg is supported by the printed circuit board, the third antenna leg having a length, with a first end region of the third antenna leg connected to the second end region of the second antenna leg, and with a second end region of the third antenna leg extending away from the first end region of the third antenna leg in a direction that is opposite to the first direction. A fourth antenna leg is supported by the printed circuit board, the fourth antenna leg having a length, with a first end region of the fourth antenna leg connected to the second end region of the third antenna leg, and with a second end region of the fourth antenna leg extending away from the first end region of the fourth antenna leg in a direction that is opposite to the second direction and toward the first antenna leg. A fifth antenna leg is supported by the printed circuit board, the fifth antenna leg having a length extending parallel to the first antenna leg with the fifth antenna leg connected to the second end region of the fourth antenna leg. A sixth antenna leg is supported by the printed circuit board, the sixth antenna leg having a length, with a first end region of the sixth antenna leg electrically coupled to an antenna signal trace of the printed circuit board, and with a second end region of the sixth antenna leg extending away from the first end region of the sixth antenna leg in a direction that is parallel with the first antenna leg and is connected to the second antenna leg at an intermediate location along the length of the second antenna leg, the sixth antenna leg spaced from the first antenna leg by a first gap along the length of the sixth antenna leg, and the sixth antenna leg extending between the first antenna leg and the fifth antenna leg and spaced from the fifth antenna leg by a second gap along the length of the fifth antenna leg.

Another example may be found in a printed circuit board implemented antenna. The illustrative printed circuit board implemented antenna includes an antenna leg supported by a printed circuit board, the printed circuit board having a plurality of different metal layers. The antenna leg has a length extending between a first end and a second end of the antenna leg. The antenna leg includes a plurality of series connected metal segments. Each of at least two of the plurality of series connected metal segments is electrically connected to at least two neighboring metal segment of the plurality of series connected metal segments, and wherein each of the at least two of the plurality of series connected metal segments is formed on a different metal layer of the printed circuit board than each of the at least two neighboring metal segment and is connected to each of the at least two neighboring metal segment through one or more Vias of the printed circuit board.

Another example may be found in a printed circuit board implemented multiband antenna. The illustrative printed circuit board implemented multiband antenna includes a plurality of antenna legs arranged within a rectangular area on a printed circuit board of less than 260 millimeters square with each formed using one or more metal layers of the printed circuit board. The plurality of antenna legs are arranged to support two different antenna modes in accordance with a selected one of two impedance-matching circuits of an antenna driving circuit, including a first antenna mode that includes a first band with a return loss of less than-10 dB at 868 MHz and a second band with a return loss of less than-10 dB at 2.4 GHz, and a second antenna mode that includes a third band with a return loss of less than-10 dB at 915 MHz and the second band with a return loss of less than-10 dB at 2.4 GHz.

The preceding summary is provided to facilitate an understanding of some of the features of the present disclosure and is not intended to be a full description. A full appreciation of the disclosure can be gained by taking the entire specification, claims, drawings, and abstract as a whole.

### BRIEF DESCRIPTION OF THE DRAWINGS

The disclosure may be more completely understood in consideration of the following description of various illustrative embodiments of the disclosure in connection with the accompanying drawings, in which:

FIG. 1 is a schematic block diagram showing an illustrative printed circuit board including a multiband antenna;

FIG. 2 is a schematic block diagram showing an illustrative device circuitry forming part of the illustrative printed circuit board of FIG. 1;

FIG. 3 is a schematic block diagram showing an illustrative impedance-matching circuit usable in the illustrative printed circuit board of FIG. 1 and tuned for dual bandwidths at 868 MHz and 2.4 GHz;

FIG. 4 is a schematic block diagram showing an illustrative impedance-matching circuit usable in the illustrative printed circuit board of FIG. 1 and tuned for dual bandwidths at 915 MHz and 2.4 GHz;

FIG. 5 is a schematic view of an illustrative multiband antenna that may represent the multiband antenna of the printed circuit board of FIG. 1;

FIG. 6 is a schematic view of the illustrative multiband antenna of FIG. 5, with particular dimensions called out;

FIG. 7 is a perspective view of a portion of the printed circuit board shown in FIG. 1, including the illustrative multiband antenna of FIG. 5;

FIG. 8 is a cross-sectional view taken along the line 8-8 of FIG. 7;

FIG. 9 is a perspective view of the illustrative multiband antenna of FIG. 5, with an intervening layer removed to show the dual layer nature of the illustrative multiband antenna of FIG. 5;

FIG. 10 is a graph showing return loss of the antenna shown in FIG. 6 with an impedance-matching circuit tuned for 868 MHz and 2.4 GHz frequencies;

FIG. 11 is a graph showing return loss of the antenna shown in FIG. 6 with an impedance-matching circuit tuned for 915 MHz and 2.4 GHz frequencies;

FIG. 12 is a graph showing efficiency of the antenna shown in FIG. 6 with an impedance-matching circuit tuned for 868 MHz and 2.4 GHz frequencies; and

FIG. 13 is a graph showing efficiency of the antenna shown in FIG. 6 with an impedance-matching circuit tuned for 915 MHz and 2.4 GHz frequencies.

While the disclosure is amenable to various modifications and alternative forms, specifics thereof have been shown by way of example in the drawings and will be described in detail. It should be understood, however, that the intention is not to limit aspects of the disclosure to the particular illustrative embodiments described. On the contrary, the intention is to cover all modifications, equivalents, and alternatives falling within the spirit and scope of the disclosure.

### DESCRIPTION

The following description should be read with reference to the drawings wherein like reference numerals indicate like elements. The drawings, which are not necessarily to scale, are not intended to limit the scope of the disclosure. In some of the figures, elements not believed necessary to an understanding of relationships among illustrated components may have been omitted for clarity.

All numbers are herein assumed to be modified by the term “about”, unless the content clearly dictates otherwise. The term “about” means within a range of plus or minus 10 percent of the expressed number. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

A multiband antenna is described herein. The multiband antenna may be an antenna formed using one or more metal layers of a Printed Circuit Board (PCB). In some cases, the multiband antenna may provide a first frequency band and a second frequency band, where the second frequency band is different from the first frequency band. As an example, the multiband antenna may provide a first frequency band that includes or is centered around 868 MHz and a second frequency band that includes or is centered around 2.4 GHz. As another example, the multiband antenna may provide a first frequency band that includes or is centered around 915 MHz and a second frequency band that includes or is centered around 2.4 GHz. In some instances, a tuned impedance-matching circuit may be used with the multiband antenna to selectively achieve the first frequency band that includes or is centered around 868 MHz and/or to selectively achieve the first frequency band that includes or is centered around 915 MHz. In some cases, the impedance-matching circuit may be tuned to achieve the desired first frequency band for use in electronic devices intended for use in a particular part of the world. As an example, a frequency band that includes or is centered at 868 MHz may be useful for electronic devices used in Europe while a frequency band that includes or is centered at 915 MHz may be useful for electronic devices used in the United States.

In some cases, the multiband antenna may be used in a building control device, such as a building controller. The building controller may be, for example, a damper actuator controller, a thermostat, a smart plug socket, a mobile remote control device, and/or any other suitable building controller device. In some cases, the multiband antenna may be used in a consumer electronics device such as a smart phone, tablet, laptop, desktop and or any other suitable consumer electronics device as desired. These are only examples and non-limiting. It is contemplated that the multiband antenna disclosed herein may be used in any suitable device.

An example multiband antenna includes a ground plane formed by one or more conductive layers of a Printed Circuit Board (PCB). In some cases, conductive layer(s) and insulative layer(s) of the PCB may have a total thickness of 1.6 millimeters or less. The PCB insulative layer(s) may be formed of, or otherwise include, FR4. FR4 is a fiberglass-reinforced epoxy laminate material, and is considered to be flame-retardant. FR-4 fiberglass epoxy has a good strength to weight ratio.

FIG. 1 is a schematic block diagram showing an illustrative printed circuit board (PCB) 10. The illustrative PCB 10 may be utilized in any of a variety of different electronic devices, particular electronic devices that are configured to communicate with other devices using more than one frequency band. The PCB 10 includes a multiband antenna 12. The multiband antenna 12 may include an antenna lead 14 that is configured to be electrically connected with a ground plane 16 of the PCB 10. The multiband antenna 12 may include an antenna lead 18 that is electrically connected with circuitry 20 that is formed on or within the PCB 10. In some instances, the circuitry 20 may include impedance-matching circuitry 22 that is tuned for a particular frequency or frequencies. For example, the impedance-matching circuitry 22 may be tuned for a first frequency band that includes or is centered around 868 MHz and a second frequency band that includes or is centered around 2.4 GHz. As another example, the impedance-matching circuitry 22 may be tuned for a first frequency band that includes or is centered around 915 MHz and a second frequency band that includes or is centered around 2.4 GHZ.

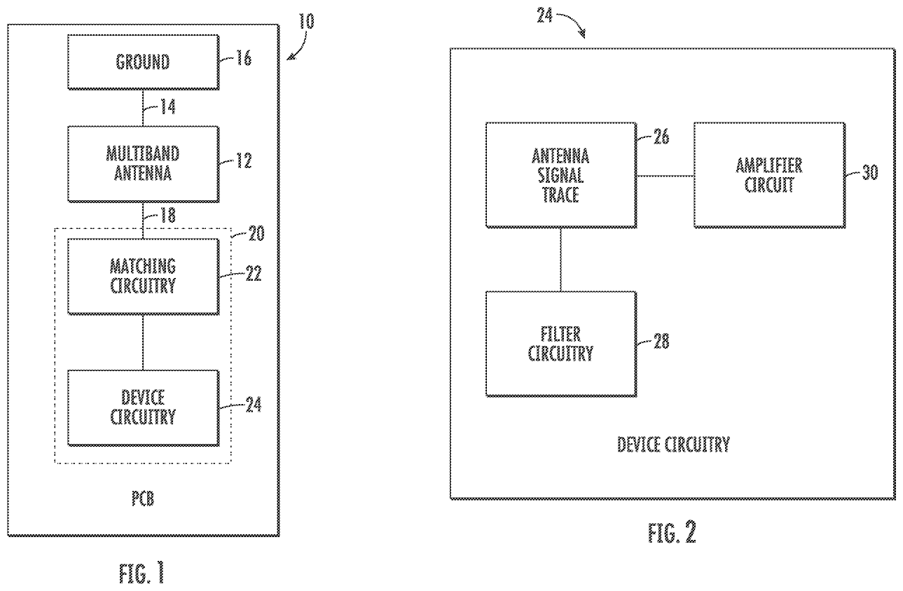

In some instances, the circuitry 20 may also include device circuitry 24. The device circuitry 24 may include any of a variety of different electronic circuits that allow the electronic device bearing the PCB 10 to function. In some instances, the device circuitry 24 may include additional circuitry that helps the electronic device to better function with the multiband antenna 12. FIG. 2 is a schematic block diagram showing illustrative device circuitry 24. As an example, the device circuitry 24 may include an antenna signal trace 26 that allows the multiband antenna 12 to be connected to various device circuitry 24. In some instances, the device circuitry 24 may include filter circuitry 28 that may be used to filter signals to and/or from the multiband antenna 12. In some cases, the device circuitry 24 may include an amplifier circuitry 30 that may be used to amplify signals to and/or from the multiband antenna 12. In some cases, the filter circuitry 28 may be interposed between the antenna signal trace 26 and the amplifier circuitry 30. The amplifier circuitry 30 may in some cases have a receive mode and/or a transmit mode. When in the receive mode, the amplifier circuitry 30 may amplifier signals received from the multiband antenna 12 via the antenna signal trace 26, and provide the amplified signals to processing and/or other circuitry (not shown) on the PCB 10. When in the transmit mode, the amplifier circuitry 30 may amplifier signals received from processing and/or other circuitry (not shown) on the PCB 10 and provide the amplified signals to the antenna signal trace 26 of the multiband antenna 12. These are just examples.

FIG. 3 is a schematic block diagram showing an illustrative impedance-matching circuitry 32 that may be considered as being an example of the impedance-matching circuitry 22 shown in FIG. 1. The illustrative impedance-matching circuitry 32 may be considered as being tuned to provide for a first frequency band that includes or is centered around 868 MHz and a second frequency band that includes or is centered around 2.4 GHz. The impedance-matching circuitry 32 is coupled between a circuit 34 that may be considered as representing the device circuitry 24 and an antenna 36 that may be considered as representing the multiband antenna 12. The impedance-matching circuitry 32 includes a first inductor 38, a second inductor 40 and a third inductor 42. In some cases, the first inductor 38 may have an inductance of 1.8 nH (nanoHenry), the second inductor 40 may have an inductance of 2.2 nH, and the third inductor 42 may have an inductance of 1.8 nH. The second inductor 40 may be coupled to ground.

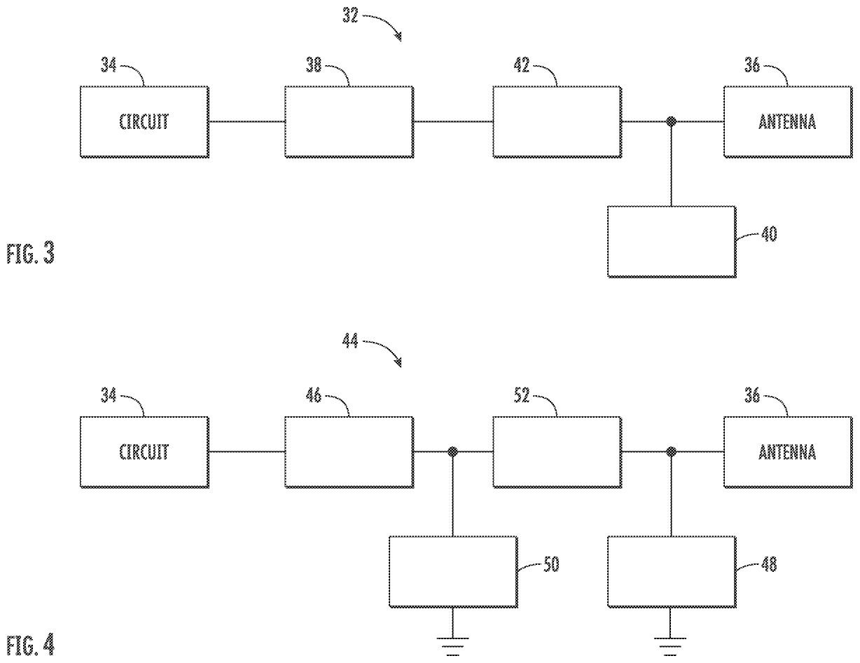

FIG. 4 is a schematic block diagram showing an illustrative impedance-matching circuitry 44 that may be considered as being an example of the impedance-matching circuitry 22 shown in FIG. 1. The illustrative impedance-matching circuitry 44 may be considered as being tuned to provide for a first frequency band that includes or is centered around 915 MHz and a second frequency band that includes or is centered around 2.4 GHz. The impedance-matching circuitry 44 is coupled between the circuit 34 that may be considered as representing the device circuitry 24 and the antenna 36 that may be considered as representing the multiband antenna 12. The impedance-matching circuitry 44 includes a first inductor 46, a second inductor 48, a first capacitor 50 and a second capacitor 52. In some cases, the first inductor 46 may have an inductance of 5.6 nH (nanoHenry) and the second inductor 48 may have an inductance of 39 nH. The first capacitor 50 may have a capacitance of 1 pF (picofarad) and the second capacitor 52 may have a capacitance of 1.8 pF. In some instances, the second inductor 48 and the first capacitor 50 may each be connected to ground.

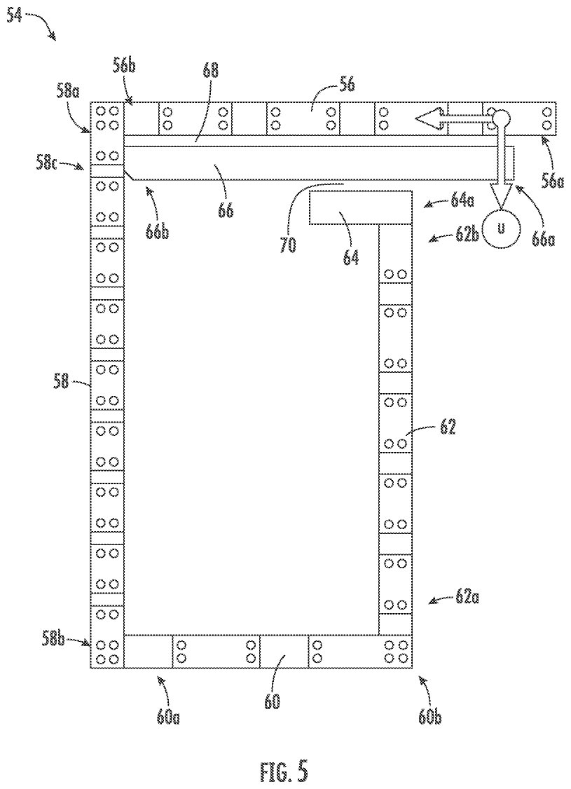

FIG. 5 is a schematic view of an illustrative multiband antenna 54. The illustrative multiband antenna 54 may be considered as being an example of the multiband antenna 12. In some instances, the multiband antenna 54 may have a first frequency band that includes or is centered at 868 mH or 915 mH, depending on impedance-matching circuitry 32 or 44, and a second frequency band that includes or is centered at 2.4 GHz. In some instances, 2.4 GHz may be considered as being a Bluetooth frequency. In some instances, the multiband antenna 54 may have a first band with a return loss of less than-10 dB at 868 MHz and a second band with a return loss of less than-10 dB at 2.4 GHZ. In some instances, the multiband antenna 54 may have a first band with a return loss of less than-10 dB at 915 MHz and a second band with a return loss of less than-10 dB at 2.4 GHz. In some cases, the multiband antenna 54 may have a first band with a return loss of less than-10 dB at 868 MHz, a second band with a return loss of less than-10 dB at 915 MHz and a third band with a return loss of less than-10 dB at 2.4 GHZ.

The illustrative multiband antenna 54 includes a first antenna leg 56, a second antenna leg 58, a third antenna leg 60, a fourth antenna leg 62, a fifth antenna leg 64 and a sixth antenna leg 66 that are each supported by a printed circuit board such as the PCB 10. The multiband antenna 54 may have a small profile in which all of the first antenna leg 56, the second antenna leg 58, the third antenna leg 60, the fourth antenna leg 62, the fifth antenna leg 64 and the sixth antenna leg 66 all fit into a rectangular area on the PCB 10 that is less than 400 square millimeters. The multiband antenna 54 may fit into a rectangular area of less than 300 square millimeters. The multiband antenna 54 may fit into a rectangular area of about 260 square millimeters. As shown, the rectangular area has dimensions of 14.70 millimeters by 17.65 millimeters, which corresponds to an area of 259.46 square millimeters.

The first antenna leg 56 has a first end region 56a that is configured to be operatively coupled to a ground plane of the printed circuit board (such as the ground 16) and a second end region 56b that extends away from the first end region 56a of the first antenna leg 56 in a first direction (to the left, in the illustrated orientation). The second antenna leg 58 has a first end region 58a that is connected to the second end region 56b of the first antenna leg 56. The second antenna leg 58 has a second end region 58b extending away from the first end region 58a in a second direction that is orthogonal to the first direction, and downward (in the illustrated orientation). The third antenna leg 60 has a first end region 60a that is connected to the second end region 58b of the second antenna leg 58. The third antenna leg 60 has a second end region 60b that extends away from the first end region 60a of the third antenna leg 60 in a direction that is opposite to the first direction. In the illustrated orientation, the second end region 60b extends towards the right. The fourth antenna leg 62 includes a first end region 62a that is connected to the second end region 60b of the third antenna leg 60. The fourth antenna leg 62 includes a second end region 62b that extends away from the first end region 62a of the fourth antenna leg 62 in a direction that is opposite to the second direction and toward the first antenna leg 56. In the illustrated orientation, the second end region 62b extends in a vertically upward direction.

The multiband antenna 54 includes a fifth antenna leg 64 that extends parallel to the first antenna leg 56. The fifth antenna leg 64 includes a first end region 64a that is connected to the second end region 62b of the fourth antenna leg 62. A sixth antenna leg 66 has a first end region 66a that is configured to be electrically coupled to an antenna signal trace (such as the antenna signal trace 26 coupled to an impedance matching circuit). The sixth antenna leg 66 includes a second end region 66b that extends away from the first end region 66a of the sixth antenna leg 66 in a direction that is parallel with the first antenna leg 56 and is connected to the second antenna leg 58 at an intermediate location 58c along a length of the second antenna leg 58, the sixth antenna leg 66 spaced from the first antenna leg 56 by a first gap 68 along the length of the sixth antenna leg 66, and the sixth antenna leg 66 extends between the first antenna leg 56 and the fifth antenna leg 64 and spaced from the fifth antenna leg 64 by a second gap 70 along a length of the fifth antenna leg 64. As an example, the first gap 68 may be about 0.3 millimeters and the second gap 70 may be about 0.3 millimeters. In some instances, the fifth antenna leg 64 may be shorter in length than the first antenna leg 56 and shorter than the length of the sixth antenna leg. In some instances, the sixth antenna leg 66 may be shorter in length than the first antenna leg 56. In some cases, the first end region 64a of the fifth antenna leg 64 may be connected to the second end region 62b of the fourth antenna leg 62.

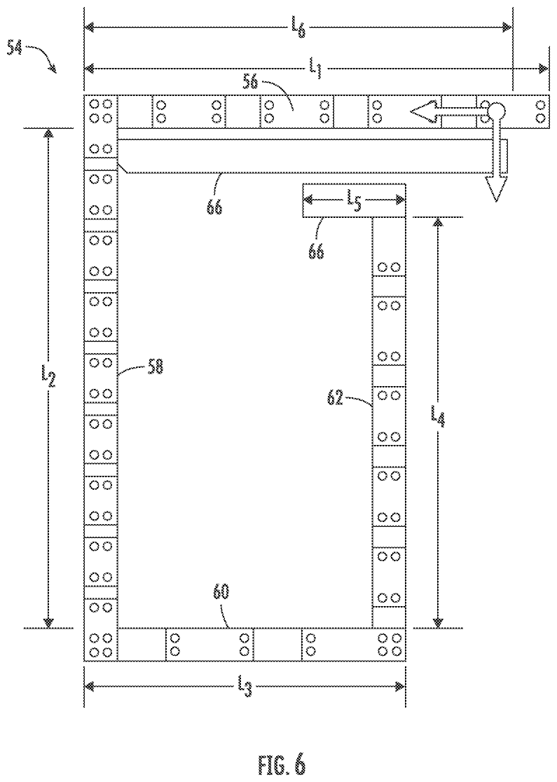

FIG. 6 is a schematic view of the illustrative multiband antenna 54 with various lengths denoted. The first antenna leg 56 may have a length L₁ that is about 14 millimeters and a width of about 1 millimeter. The term “about” is defined as being plus or minus up to twenty percent. Thus, “about 14 millimeters” would have a range of 11.2 millimeters to 16.8 millimeters and “about 1 millimeter” would range from 0.8 millimeters to 1.2 millimeters. The second antenna leg 58 may have a length L₂ that is about 15 millimeters and a width of about 1 millimeter. The third antenna leg 60 may have a length L₃ that is about 10 millimeters and a width of about 1 millimeter. The fourth antenna leg 62 may have a length L₄ that is about 13 millimeters and a width of about 1 millimeter. The fifth antenna leg 64 may have a length L₅ that is about 3 millimeters and a width of about 1 millimeter. The sixth antenna leg 66 may have a length L₆ that is about 12 millimeters and a width of about 1 millimeter.

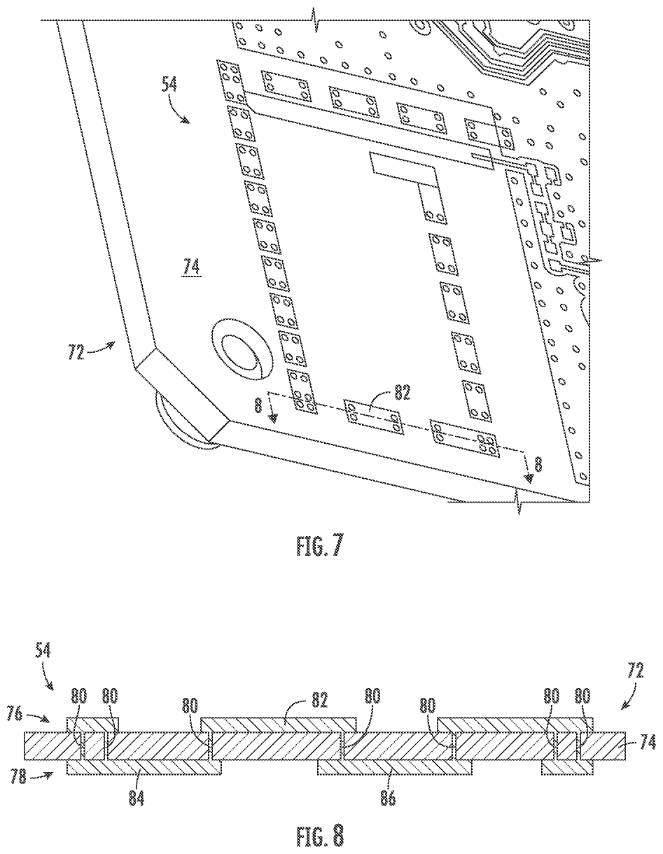

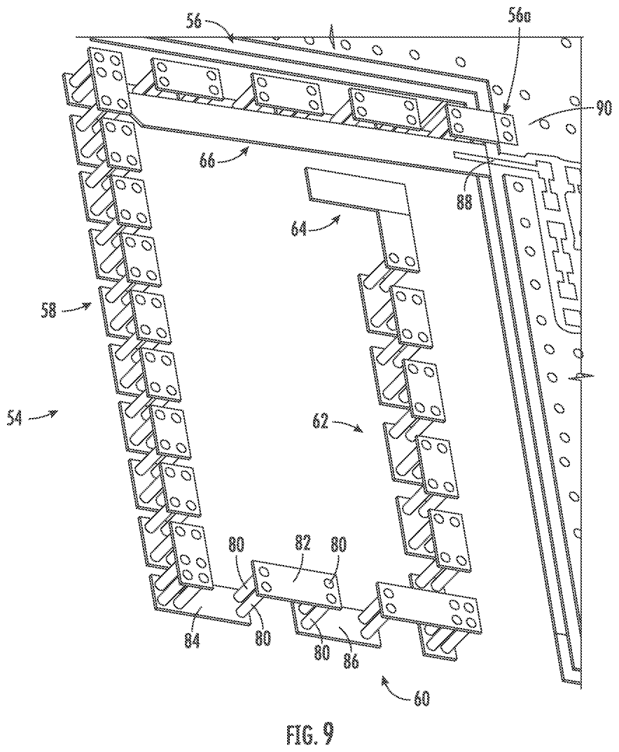

In some instances, the multiband antenna 54 may be formed as part of a printed circuit board (such as the PCB 10). As an example, each of the first antenna leg 56, the second antenna leg 58, the third antenna leg 60, the fourth antenna leg 62, the fifth antenna leg 64 and the sixth antenna leg 66 may each be formed using metal traces of a printed circuit board. In some instances, the multiband antenna 54 may be a multi-layer construction. FIG. 7 is a top perspective view of a printed circuit board 72 including the multiband antenna 54. FIG. 8 is a cross-sectional view of the printed circuit board 72, taken along the line 8-8 of FIG. 7. FIG. 9 is a perspective view of the multiband antenna 54, showing the metal layers of the multiband antenna 54 with an intervening dielectric layer (e.g. FR4) 74 removed for clarity.

The illustrative printed circuit board 72 includes a conductive layer 76 that as shown in FIG. 8 is positioned above (in the illustrated orientation) the dielectric layer 74 and a conductive layer 78 that is positioned below the dielectric layer 74. Each of the first antenna leg 56, the second antenna leg 58, the third antenna leg 60, the fourth antenna leg 62, the fifth antenna leg 64 and the sixth antenna leg 66 may be formed of alternating segments, with some segments being part of the conductive layer 76 and some segments being part of the conductive layer 78. A number of Vias 80 extend between the conductive layer 76 and the conductive layer 78 in order to electrically couple adjacent metal segments. In some instances, forming each of the of the first antenna leg 56, the second antenna leg 58, the third antenna leg 60, the fourth antenna leg 62, the fifth antenna leg 64 and the sixth antenna leg 66 of alternating metal segments, where each metal segment has neighboring metal segments physically separated from the metal segments via the intervening dielectric layer 74, can effectively increase the electrical length of each of the first antenna leg 56, the second antenna leg 58, the third antenna leg 60, the fourth antenna leg 62, the fifth antenna leg 64 and the sixth antenna leg 66.

In some instances, one or more of the first antenna leg 56, the second antenna leg 58, the third antenna leg 60, the fourth antenna leg 62, the fifth antenna leg 64 and the sixth antenna leg 66 include a plurality of series connected metal segments, wherein each of the plurality of series connected metal segments is electrically connected to at least two neighboring metal segment in the plurality of series connected metal segments, and wherein each of the plurality of series connected metal segments is formed on a different metal layer of the printed circuit board than each of the at least two neighboring metal segment and is connected to each of the at least two neighboring metal segment through one or more Vias 80 of the printed circuit board 72. In some cases, one or more of the first antenna leg 56, the second antenna leg 58, the third antenna leg 60, the fourth antenna leg 62, the fifth antenna leg 64 and the sixth antenna leg 66 each include at least four series connected metal segments that alternate between a first metal conductive layer 76 and a second metal conductive layer 78 of the printed circuit board 72 and are series connected using Vias 80 of the printed circuit board 72.

To illustrate, consider a portion of the third antenna leg 60 that includes a metal segment 82, a metal segment 84 and a metal segment 86 (see, for example, FIG. 8). The metal segment 82 is formed as part of the conductive layer 76. The metal segment 84 and the metal segment 86 are each formed as part of the conductive layer 78, and thus are spaced apart from the metal segment 82 by the dielectric layer (e.g. FR4) 74 (removed for clarity in FIG. 9). The metal segment 82 is electrically coupled with the metal segment 84 and the metal segment 86 by a number of Vias 80 that extend between the conductive layer 76 and the conductive layer 78. In some instances, the first end region 66a of the sixth antenna leg 66 may be electrically coupled with an antenna signal trace 88. The antenna signal trace 88 may be considered as being an example of the antenna signal trace 26 schematically shown in FIG. 2. The first end region 56a of the first antenna leg 56 may be electrically coupled with a ground plane 90, which may be considered as an example of the ground 16.

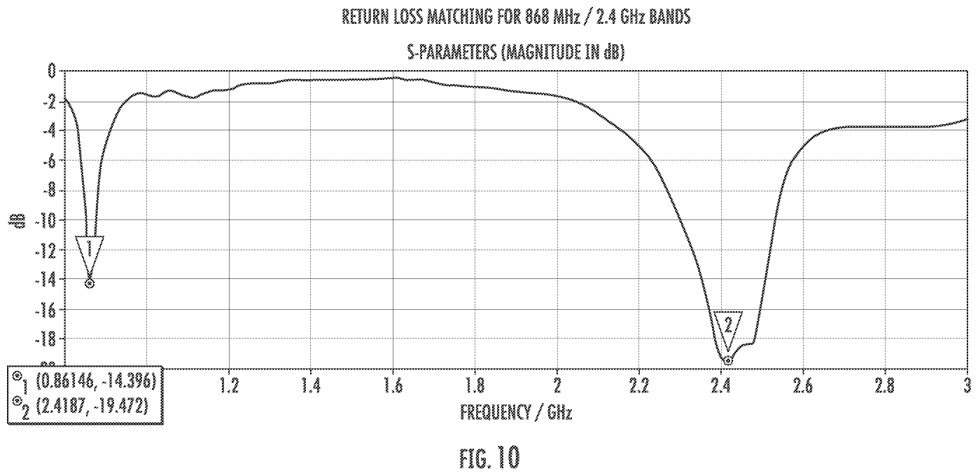

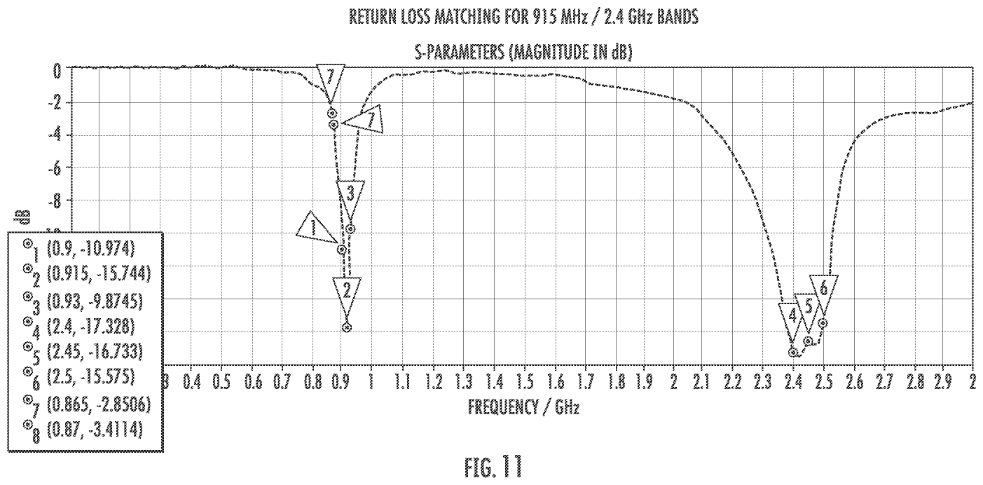

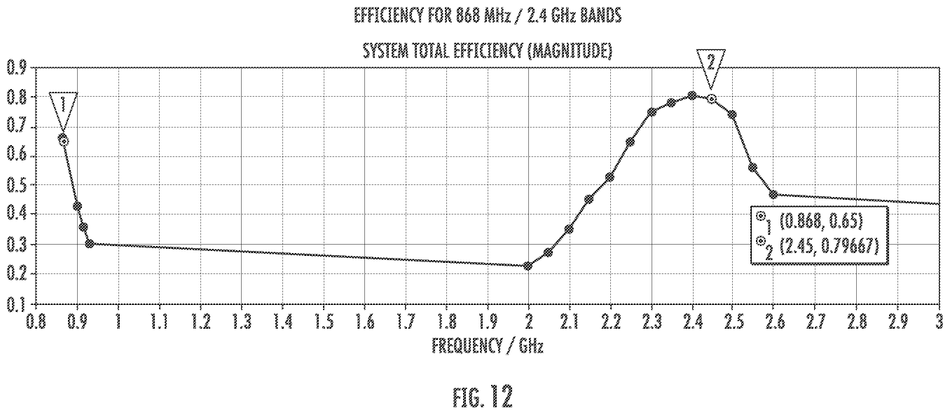

FIG. 10 is a graph showing return loss of the antenna shown in FIG. 6 with an impedance-matching circuit tuned for 868 MHz and 2.4 GHz frequencies. FIG. 10 shows results for the multiband antenna 54 used in combination with an impedance-matching circuit (such as the impedance-matching circuitry 32) to produce a first trough (in return loss) around 868 Mhz and a second trough (in return loss) around 2.4 GHz. FIG. 11 is a graph showing return loss of the antenna shown in FIG. 6 with an impedance-matching circuit tuned for 915 MHz and 2.4 GHz frequencies. FIG. 11 shows results for the multiband antenna 54 used in combination with an impedance-matching circuit (such as the impedance-matching circuitry 44) to produce a first trough (in return loss) around 915 Mhz and a second trough (in return loss) around 2.4 GHZ.

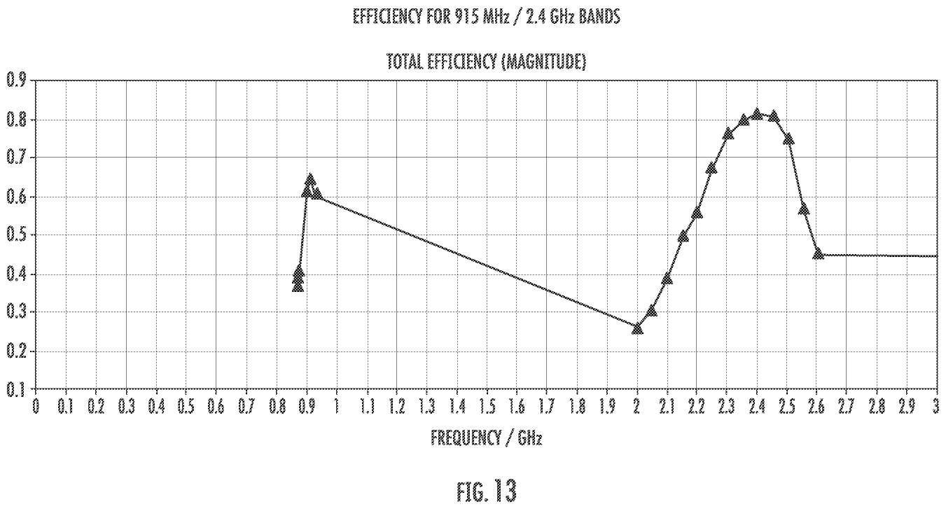

FIG. 12 is a graph showing efficiency of the antenna shown in FIG. 6 with an impedance-matching circuit tuned for 868 MHz and 2.4 GHz frequencies. FIG. 12 shows results for the multiband antenna 54 used in combination with an impedance-matching circuit (such as the impedance-matching circuitry 32) to produce a first peak (in efficiency) around 868 Mhz and a second peak (in efficiency) around 2.4 GHz. FIG. 11 is a graph showing efficiency of the antenna shown in FIG. 6 with an impedance-matching circuit tuned for 915 MHz and 2.4 GHz frequencies. FIG. 13 shows results for the multiband antenna 54 used in combination with an impedance-matching circuit (such as the impedance-matching circuitry 44) to produce a first peak (in efficiency) around 915 Mhz and a second peak (in efficiency) around 2.4 GHz.

Some of the matter disclosed herein may be of a hypothetical or prophetic nature although stated in another manner or tense. Although the present system and/or approach has been described with respect to at least one illustrative example, many variations and modifications will become apparent to those skilled in the art upon reading the specification. This may include, to the extent that it is appropriate, the use of any of the features of one example embodiment being used in other embodiments. It is therefore the intention that the appended claims be interpreted as broadly as possible in view of the related art to include all such variations and modifications.

What is claimed is:

1. A printed circuit board implemented multiband antenna, comprising
a first antenna leg supported by a printed circuit board, the first antenna leg having a length, with a first end region of the first antenna leg operatively connected to a ground plane of the printed circuit board and a second end region of the first antenna leg extending away from the first end region of the first antenna leg in a first direction;
a second antenna leg supported by the printed circuit board, the second antenna leg having a length, with a first end region of the second antenna leg connected to the second end region of the first antenna leg, and with a second end region of the second antenna leg extending away from the first end region of the second antenna leg in a second direction that is orthogonal to the first direction;
a third antenna leg supported by the printed circuit board, the third antenna leg having a length, with a first end region of the third antenna leg connected to the second end region of the second antenna leg, and with a second end region of the third antenna leg extending away from the first end region of the third antenna leg in a direction that is opposite to the first direction;
a fourth antenna leg supported by the printed circuit board, the fourth antenna leg having a length, with a first end region of the fourth antenna leg connected to the second end region of the third antenna leg, and with a second end region of the fourth antenna leg extending away from the first end region of the fourth antenna leg in a direction that is opposite to the second direction and toward the first antenna leg;
a fifth antenna leg supported by the printed circuit board, the fifth antenna leg having a length extending parallel to the first antenna leg with the fifth antenna leg connected to the second end region of the fourth antenna leg; and
a sixth antenna leg supported by the printed circuit board, the sixth antenna leg having a length, with a first end region of the sixth antenna leg electrically coupled to an antenna signal trace of the printed circuit board, and with a second end region of the sixth antenna leg extending away from the first end region of the sixth antenna leg in a direction that is parallel with the first antenna leg and is connected to the second antenna leg at an intermediate location along the length of the second antenna leg, the sixth antenna leg spaced from the first antenna leg by a first gap along the length of the sixth antenna leg, and the sixth antenna leg extending between the first antenna leg and the fifth antenna leg and spaced from the fifth antenna leg by a second gap along the length of the fifth antenna leg.

2. The printed circuit board implemented multiband antenna of claim 1, wherein the length of the fifth antenna leg is shorter than the length of the first antenna leg and shorter than the length of the sixth antenna leg.

3. The printed circuit board implemented multiband antenna of claim 1, wherein the length of the sixth antenna leg is shorter than the length of the first antenna leg.

4. The printed circuit board implemented multiband antenna of claim 1, wherein a first end region of the fifth antenna leg is connected to the second end region of the fourth antenna leg.

5. The printed circuit board implemented multiband antenna of claim 1, wherein:
the first antenna leg has a length of about 14 millimeters and a width of about 1 millimeter;
the second antenna leg has a length of about 15 millimeters and a width of about 1 millimeter;
the third antenna leg has a length of about 10 millimeters and a width of about 1 millimeter;
the fourth antenna leg has a length of about 13 millimeters and a width of about 1 millimeter;
the fifth antenna leg has a length of about 3 millimeters and a width of about 1 millimeter; and
the sixth antenna leg has a length of about 12 millimeters and a width of about 1 millimeter.

6. The printed circuit board implemented multiband antenna of claim 2, wherein the first gap is about 0.3 millimeters and the second gap is about 0.3 millimeters.

7. The printed circuit board implemented multiband antenna of claim 1, comprising a first band with a return loss of less than-10 dB at 868 MHz and a second band with a return loss of less than-10 dB at 2.4 GHz.

8. The printed circuit board implemented multiband antenna of claim 1, comprising a first band with a return loss of less than-10 dB at 915 MHz and a second band with a return loss of less than-10 dB at 2.4 GHz.

9. The printed circuit board implemented multiband antenna of claim 1, comprising a first band with a return loss of less than-10 dB at 868 MHz, a second band with a return loss of less than-10 dB at 915 MHz and a third band with a return loss of less than-10 dB at 2.4 GHz.

10. The printed circuit board implemented multiband antenna of claim 1, wherein the first antenna leg, the second antenna leg, the third antenna leg, the fourth antenna leg, the fifth antenna leg and the sixth antenna leg collectively fit within a rectangular area on the printed circuit board of less than 400 square millimeters.

11. The printed circuit board implemented multiband antenna of claim 1, wherein the first antenna leg, the second antenna leg, the third antenna leg, the fourth antenna leg, the fifth antenna leg and the sixth antenna leg are each are formed using traces of the printed circuit board.

12. The printed circuit board implemented multiband antenna of claim 1, wherein the printed circuit board has a plurality of different metal layers, and wherein one or more of the first antenna leg, the second antenna leg, the third antenna leg, the fourth antenna leg, the fifth antenna leg and the sixth antenna leg include a plurality of series connected metal segments, wherein each of the plurality of series connected metal segments is electrically connected to at least two neighboring metal segment in the plurality of series connected metal segments, and wherein each of the plurality of series connected metal segments is formed on a different metal layer of the printed circuit board than each of the at least two neighboring metal segment and is connected to each of the at least two neighboring metal segment through one or more VIAS of the printed circuit board.

13. The printed circuit board implemented multiband antenna of claim 12, wherein one or more of the first antenna leg, the second antenna leg, the third antenna leg, the fourth antenna leg, the fifth antenna leg and the sixth antenna leg each include at least four series connected metal segments that alternate between a first metal layer and a second metal layer of the plurality of different metal layers of the printed circuit board and are series connected using VIAS of the printed circuit board.

14. The printed circuit board implemented multiband antenna of claim 1, wherein the antenna signal trace of the printed circuit board is operatively coupled to filter circuitry and/or amplifier circuitry mounted to the printed circuit board.

15. The printed circuit board implemented multiband antenna of claim 1, wherein the antenna signal trace of the printed circuit board is operatively coupled to circuitry mounted to the printed circuit board, wherein the circuitry is impedance matched to the printed circuit board implemented multiband antenna.

16. A printed circuit board implemented antenna, comprising
an antenna leg supported by a printed circuit board, the printed circuit board having a plurality of different metal layers;
the antenna leg having a length extending between a first end and a second end of the antenna leg, the antenna leg including a plurality of series connected metal segments; and
wherein each of at least two of the plurality of series connected metal segments is electrically connected to at least two neighboring metal segment of the plurality of series connected metal segments, and wherein each of the at least two of the plurality of series connected metal segments is formed on a different metal layer of the printed circuit board than each of the at least two neighboring metal segment and is connected to each of the at least two neighboring metal segment through one or more Vias of the printed circuit board.

17. The printed circuit board implemented antenna of claim 16, wherein the antenna leg includes at least four series connected metal segments that alternate between a first metal layer and a second metal layer of the plurality of different metal layers of the printed circuit board and are series connected using Vias of the printed circuit board.

18. The printed circuit board implemented antenna of claim 16, comprising:
a plurality of antenna legs each supported by the printed circuit board;
each of the plurality of antenna legs having a length extending between a first end and a second end of the respective antenna leg, with the respective antenna leg including a plurality of series connected metal segments; and
wherein each of at least two of the plurality of series connected metal segments of the respective antenna leg is electrically connected to at least two neighboring metal segment in the plurality of series connected metal segments of the respective antenna leg, and wherein each of the plurality of series connected metal segments of the respective antenna leg is formed on a different metal layer of the printed circuit board than each of the at least two neighboring metal segment of the respective antenna leg and is connected to each of the at least two neighboring metal segment of the respective antenna leg through one or more Vias of the printed circuit board.

19. A printed circuit board implemented multiband antenna, comprising:
a plurality of antenna legs arranged within a rectangular area on a printed circuit board of less than 260 millimeters square with each formed using one or more metal layers of the printed circuit board, the plurality of antenna legs arranged to support two different antenna modes in accordance with a selected one of two impedance-matching circuits of an antenna driving circuit, including:
a first antenna mode that includes a first band with a return loss of less than-10 dB at 868 MHz and a second band with a return loss of less than-10 dB at 2.4 GHz; and
a second antenna mode that includes a third band with a return loss of less than-10 dB at 915 MHz and the second band with a return loss of less than-10 dB at 2.4 GHz.

20. The printed circuit board implemented multiband antenna of claim 19, wherein one or more of the plurality of antenna legs include at least four series connected metal segments that alternate between a first metal layer and a second metal layer of a plurality of different metal layers of the printed circuit board and are series connected using Vias of the printed circuit board.
